(19) United States
(12) Patent Application Publication
(10) Pub. No.: US 2010/0090642 A1
(43) Pub. Date: Apr. 15, 2010

(54) POWER ADAPTOR FOR PORTABLE FUEL CELL SYSTEM

(75) Inventors: Jennifer E. BRANTLEY, Dublin, CA (US); Ian W. KAYE, Livermore, CA (US); Robert David RICHARDSON, Danville, CA (US); Gerry TUCKER, Pleasanton, CA (US)

Correspondence Address: Beyer Law Group LLP, P.O. BOX 1687, Cupertino, CA, 95015-1687, US

(73) Assignee: ULTRACELL CORPORATION, Livermore, CA (US)

(21) Appl. No.: 12/249,870

(22) Filed: Oct. 10, 2008

(51) Int. Cl. H01M 10/46

(52) U.S. Cl. 320/101

(57) ABSTRACT

A power adaptor for use with a portable fuel cell system may have an adapter housing having at least one external surface and a battery receiving region, the battery receiving region configured to at least partially receive a battery, a first set of electrical contacts provided on the at least one external surface of the adapter housing, a power source interface provided within the battery receiving region of the adapter housing, the power source interface in electrical communication with the first set of electrical contacts, and at least one mechanical connector provided in or on the adapter housing to facilitate detachable attachment of the adapter housing to a fuel cell system housing.

### FIELD OF THE INVENTION

The present disclosure relates generally to fuel cell systems. More specifically, the present disclosure relates generally to power adaptors for use with a portable fuel cell system.

### BACKGROUND

Consumer, military and industrial ruggedized portable electronics devices and other portable electrical applications still mainly rely on lithium ion and other battery technologies. Conventional batteries are heavy relative to their energy capacity. Portable fuel cell systems, however, offer higher energy densities, particularly when they use a liquid fuel.

Portable fuel cell systems, however, offer higher energy densities, particularly when they use a liquid fuel. The portability constrains fuel cell system design and adds challenging design criteria such as weight, space, and managing elevated fuel cell system temperatures while adhering to portable electronics device skin temperature standards. At this point, portable fuel cell systems are still relatively new in their consumer adoption life cycle; product reliability and low maintenance are imperative to gaining consumer confidence and widespread market use.

### OVERVIEW

Described herein is an external power adaptor for use with a fuel cell system. The adaptor receives one or more particular battery shapes; multiple adaptors each configured for different battery shapes but commonly coupled to the fuel cell system permit the system to interface with different batteries.

In one embodiment, a power adaptor for use with a portable fuel cell system has: an adapter housing having at least one external surface and an internal region, a first set of electrical contacts provided about the at least one external surface of the adapter housing, a power source interface provided within the internal region of the adapter housing, and at least one mechanical connector provided in or on the adapter housing to facilitate detachable attachment of the adapter to a fuel cell system housing. The internal region is configured to at least partially receive a battery. The power source interface is in electrical communication with the first set of electrical contacts.

In another embodiment, a fuel cell system may have a fuel cell system housing and a fuel cell within the housing. The fuel cell system may have a first set of electrical contacts positioned about an external surface of the fuel cell system housing and a fuel source connector configured to receive the fuel source. A first power adaptor for detachably coupling to an external portion of the fuel cell housing may include i) a second set of electrical contacts configured to be in electrical communication with the first set of electrical contacts when the power adaptor is detachably coupled to the external portion of the fuel cell system housing; ii) a first mechanical connector configured to detachably couple the first power adaptor to the coupling portion of the fuel cell system; and iii) a first battery receiver configured to receive a first battery, the first battery receiver having a third set of electrical contacts in electrical communication with the second set of electrical contacts and in electrical communication with the first battery when the first battery is detachably coupled to the first power adaptor. A second power adaptor for detachably coupling to the second external portion of the fuel cell housing includes: i) a fourth set of electrical contacts configured to be in electrical connection with the first set of electrical contacts when the power adaptor is detachably coupled to the external portion of the fuel cell system housing; ii) a second mechanical connector configured to detachably couple the second power adaptor to the coupling portion of the fuel cell system housing; and iii) a second battery receiver configured to receive a second battery, the second battery receiver having a fifth set of electrical contacts in electrical communication with the fourth set of electrical contacts and in electrical communication with the second battery when the second battery is detachably coupled to the second power adaptor.

In still another embodiment, a method for regulating power in a fuel cell system comprises measuring a power demand of an external load, determining a voltage from an external power adaptor having a rechargeable battery, determining a power limit for a fuel cell included in the fuel cell system, providing power from the rechargeable battery to the load when the power demand from the external load is greater than the power limit for the fuel cell, and providing power to the rechargeable battery from the fuel cell when the power demand from the load is less than the power limit for the fuel cell.

Other hardware configured to perform the methods of the invention, as well as software stored in a machine-readable medium (e.g., a tangible storage medium) to control devices to perform these methods are disclosed. These and other features will be presented in more detail in the following detailed description of the invention and the associated figures.

### BRIEF DESCRIPTION OF THE DRAWINGS

The accompanying drawings, which are incorporated into and constitute a part of this specification, illustrate one or more example embodiments and, together with the description of example embodiments, serve to explain the principles and implementations.

FIGS. 1A-1D illustrate a power adaptor for use in a portable fuel cell system.

FIGS. 2A-2D illustrate the power adaptor of FIG. 1A in use with a portable fuel cell system.

FIGS. 3A and 3B illustrate another embodiment of a power adaptor for use in a portable fuel cell system.

FIGS. 4A-4C illustrate the power adaptor of FIG. 3A in use with a portable fuel cell system.

FIG. 5 illustrates a simplified electrical diagram of a power flow in the portable fuel cell system in accordance with specific embodiments.

FIG. 6 illustrates a method for regulating power in a portable fuel cell system.

FIGS. 7A-7B illustrate a portable fuel cell system.

FIG. 8 illustrates a computer system, which is suitable for implementing the software applications used in one or more embodiments of the present disclosure.

### DESCRIPTION OF EXAMPLE EMBODIMENTS

Embodiments are described herein in the context of a power adaptor for use with a portable fuel cell system. The following detailed description is illustrative only and is not intended to be in any way limiting. Other embodiments will readily suggest themselves to such skilled persons having the benefit of this disclosure. Reference will now be made in detail to implementations as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

A power adaptor used with a portable fuel cell system may be configured to support one or more particular battery shapes, which then may support various battery types that include those shapes. Not including the battery within the fuel cell system, but rather on a power adaptor coupled to the fuel cell system, allows a user to easily exchange the battery for another without having to return the portable fuel cell system to the manufacturer when the battery fails or ages. This results in less cost, less fuel cell system down-time, and less man-power to service a battery.

Furthermore, another power adaptor—configured to receive another battery shape and any battery types that fit that shape—allows a user to use a variety of batteries with the portable fuel cell system. This provides a user with additional flexibility and provides for a more flexible portable fuel cell system.

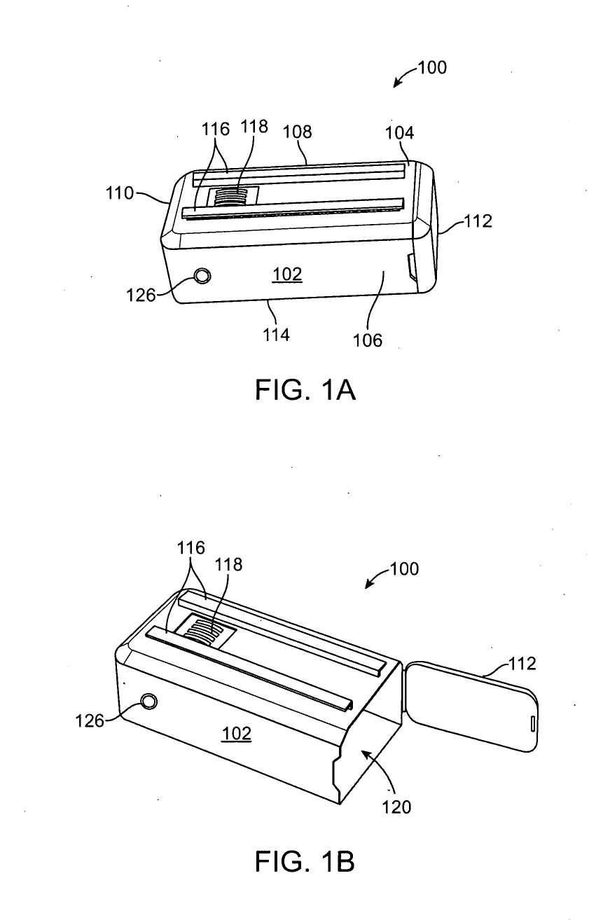

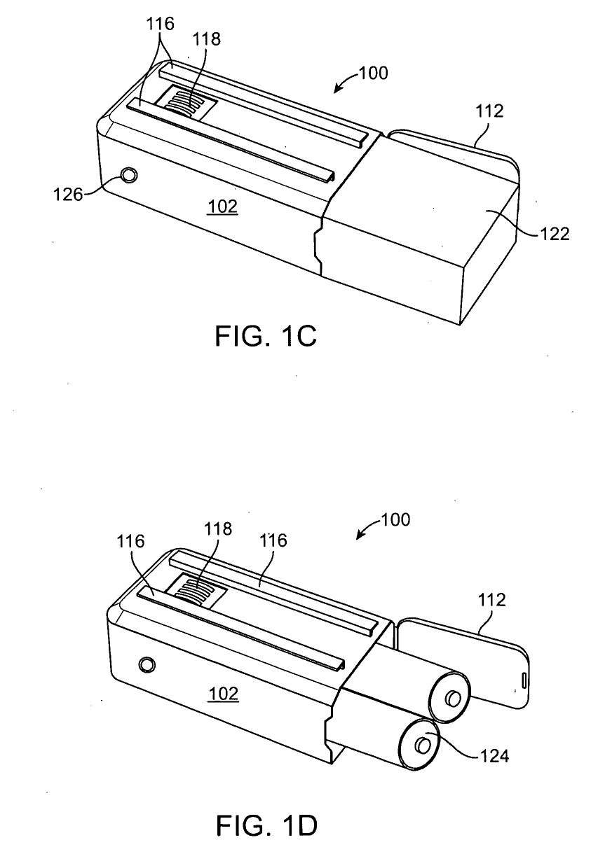

FIGS. 1A-1D illustrate a power adaptor for use with a portable fuel cell system in accordance with one embodiment. FIG. 1A illustrates the power adaptor with its door 112 in a closed position, FIG. 1B illustrates the power adaptor with its door 112 in an open position, FIG. 1C illustrates a power adaptor in use with a first battery, and FIG. 1D illustrates another power adaptor in use with a second set of batteries.

The power adaptor 100 has an adapter housing 102 that provides mechanical protection for an internal cavity and provides mechanical structure for the adaptor 100. As shown, housing 102 has a set of walls that form a top surface 104, a bottom surface 114, a first side 108, a second side 106, a first end 110, and a second end 112 configured as a door to provide entry into an interior region or battery receiving region 120 of the adaptor 100. The walls form a battery receiving region 120. The adaptor housing 102 may be made of any durable, light weight material such as plastic, aluminum, and the like. Other shapes and housing configurations are contemplated and suitable for use.

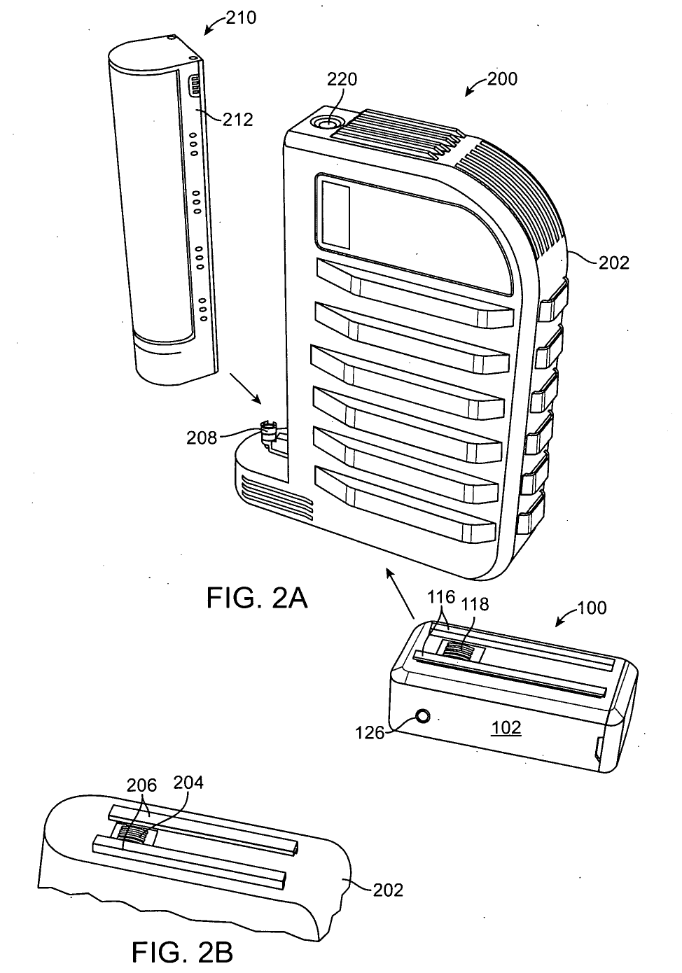

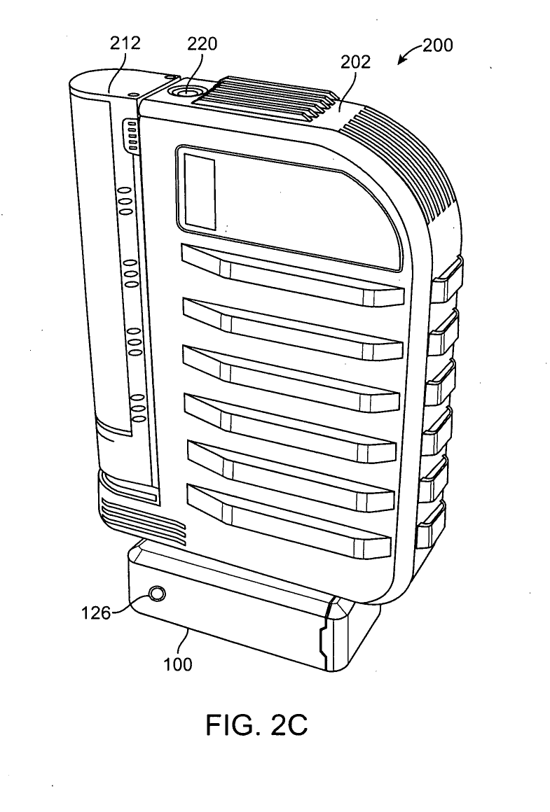

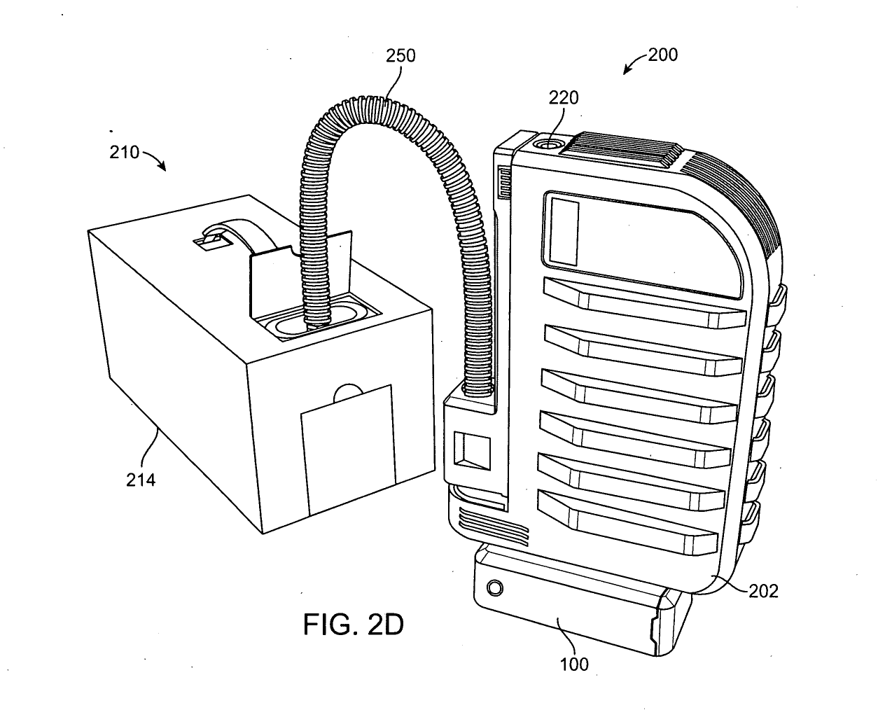

Power adaptor 100 has a mechanical connector 116 on its top surface 104 to facilitate mechanical detachment or mechanical attachment of the adapter housing 102 to a fuel cell system housing 202 (FIG. 2A). As further described below with reference to FIG. 2A, the mechanical connector 116 slideably engages a mating sliding connector on the fuel cell system housing 202. Although illustrated as elongated rails to slideably engage the fuel cell system housing 202, this is not intended to be limiting as any suitable commercially available or custom mechanical connector may be used to mechanically and detachably secure the power adaptor 100 to the fuel cell system housing 202. Other suitable mechanical connectors may include snap-fit mechanical connectors, clips, bolts, adhesives, and the like. Furthermore, although illustrated positioned on the top surface 104, the mechanical connector 116 may be provided in or on any other surface of the power adaptor 100.

Power adaptor 100 also has electrical contacts 118 on top surface 104. As described in detail below with reference to FIG. 2A, when the power adapter 100 is coupled to the fuel cell system housing 202 via mechanical connector 116, the electrical contacts 118 are in electrical communication with electrical contacts 204 on the fuel cell system housing 202 (FIG. 2B). Although electrical contact 118 is illustrated as a slide contact, other electrical contacts are contemplated. The contact may be any type of physical interface desired and be any shape, size, or form such as a plug and socket, screw terminals, fast-on or quick-disconnect terminals, universal serial bus connectors, or the like.

The second end 112 includes a door that permits opening of the adaptor housing 102 to thereby expose a battery receiving region 120 of the power adaptor 100. The battery receiving region 120 may be configured to at least partially receive a battery 122, 124 as illustrated in FIGS. 1C and 1D. Although illustrated with the second end 112 as being hinged to the housing, this is not intended to be limiting as any other surfaces of the housing may be hinged or otherwise removably coupled to the housing, such as the first end 110, the first side 106, or any others. Additionally, the second end 112 may be removably coupled to the housing using any suitable commercially available or custom mechanical connector such as a mechanical clip, snap-fit, bolt, or the like.

As illustrated in FIGS. 1C and 1D, the power adaptor 100 has a battery receiving region 120 configured to receive various different types of batteries 122, 124. The batteries may include a lithium-ion battery, nickel cadmium battery, lithium polymer, and rechargeable CFX batteries (lithium carbon monofluoride), or the like. Other example batteries may include rechargeable BB-2590, BB-2847, and BB-2800 made by Bren-Tronics, Inc. of Commack, N.Y. and LI-80 and LI-145 batteries made by UltraLife Corporation of Newark, N.Y. Battery sizes and voltages may also vary. Suitable battery sizes and battery voltages for a battery may include AA, C, D, 18650, 1.5V, 3V, 6V, 9V, 12 V, or the like.

The battery receiving region 120 of the adapter housing 102 includes a power source interface (not shown) configured to receive the battery 122, 124. The power source interface provides electrical communication between the battery and contacts 118. The power source interface is in electrical communication with the battery 122, 124 and the electrical contacts 118 on the power adaptor 100. The power source interface may include any internal or external wiring that accomplishes this task and may vary based upon the type of battery used and adaptor shape. This provides the flexibility for a user to use any type of battery desired with the fuel cell system.

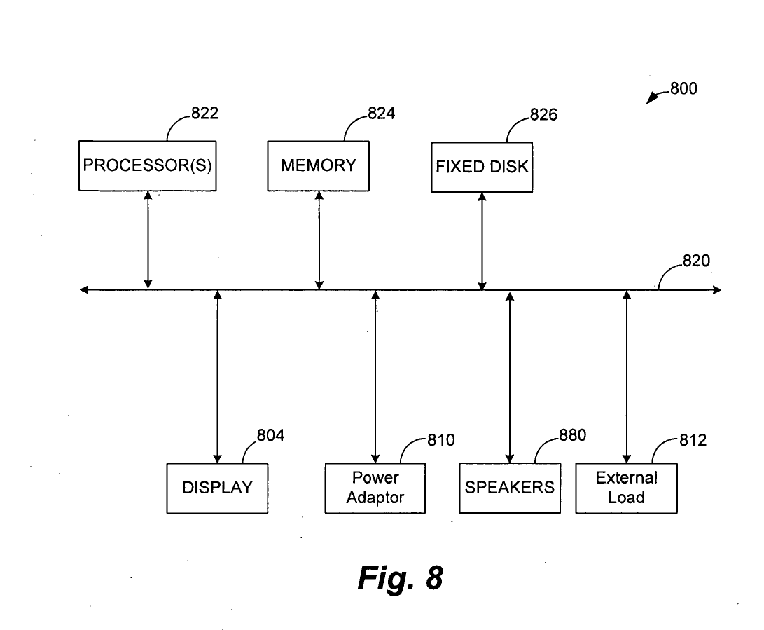

The power adaptor 100 includes a data port 126 positioned on a surface of the power adaptor 100. The data port 126 is configured to communicate with a processor 802 (FIG. 8A). The processor 802 may have at least one power management controller configured to i) determine an amount of power to be provided to the fuel cell system 200 and a power output of the battery 122, 124; ii) obtain and provide information about the battery 122, 124; and iii) detect the operational state of the fuel cell system 200. The processor 802 may be in communication with a memory 804 (FIG. 8A) storing a software application operable to provide information concerning the battery 122, 124 and the fuel cell system 200 to a computing device (further discussed with reference to FIGS. 8A and 8B) via the data port 126. The software application may allow the user to receive information about the battery and/or fuel cell system as well as control the power input and output from the battery 122, 124, fuel cell system 200, and/or an external power source via the power management controller.

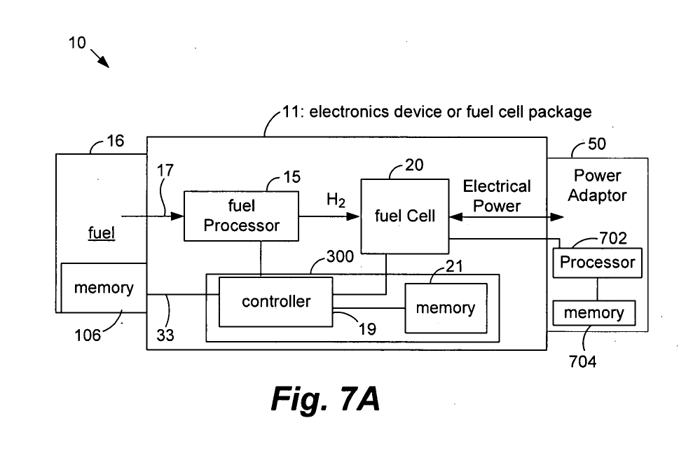

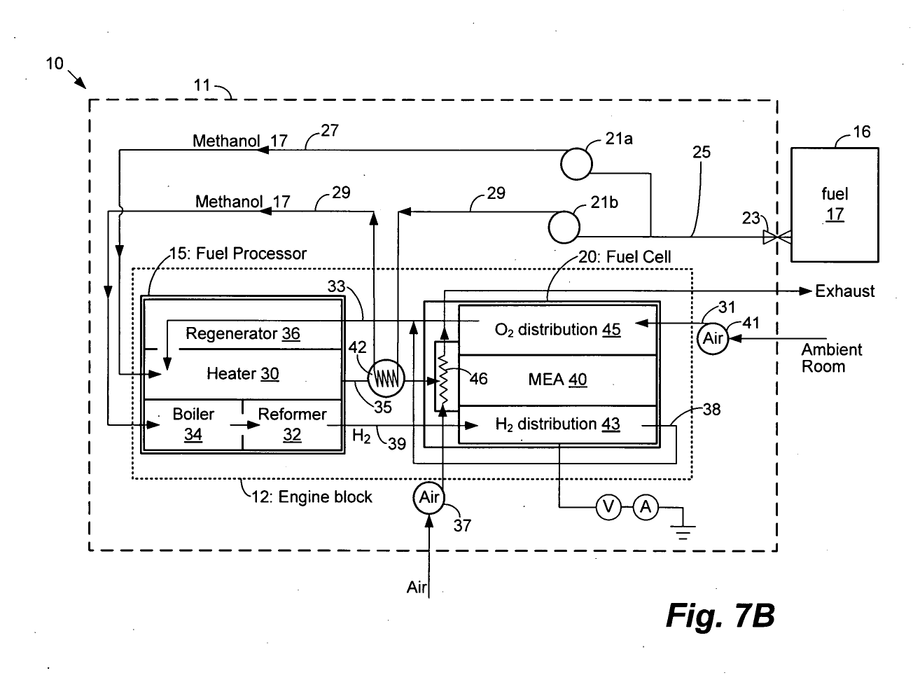

FIGS. 2A-2D illustrate the power adaptor of FIG. 1A in use with a portable fuel cell system. FIG. 2A illustrates the detached assembly of one embodiment of the fuel cell system, FIG. 2B illustrates the bottom surface of the fuel cell system housing, and FIG. 2C illustrates the fuel cell system of FIG. 2A in an assembled state. The fuel cell system 200 includes a fuel cell housing 202 enclosing a fuel cell; one suitable portable system is further described below with reference to FIGS. 7A-7B. As illustrated in FIG. 2B, the fuel cell housing 202 has electrical contacts 204 positioned on a surface of the fuel cell system housing 202. The fuel cell housing 202 also has a counterpart mechanical connector 206 configured to receive the mechanical connector 118 on the power adaptor 100. Although illustrated with the mechanical connector 118 slideably received by the counterpart mechanical connector 206, this is not intended to be limiting as any suitable commercially available or custom mechanical connector may be used.

For example the power adaptor 100 may be clipped or snap-fitted onto the fuel cell housing. In one embodiment, a snap-fit mechanical connector may be used with a plug and socket electrical contact.

When the power adapter 100 detachably couples to the fuel cell system housing 202 via the mechanical connector 116 and counterpart mechanical connector 206, the electrical contacts 118 on the power adaptor 100 are in electrical communication with the electrical contacts 204 on the fuel cell system housing 202. The battery 122 or 124 then supplies electrical energy to the fuel cell system 200 via the power source interface and the electrical contacts 118 of the power adapter 100. The power adaptor 100 may be configured to output a constant or variable voltage from the electrical contacts 118 on the power adaptor 100 to the electrical contacts 204 on the fuel cell housing 204.

The fuel cell system 200 also includes a fuel source connector 208 detachably coupled to a portion of the fuel cell housing 202, as shown in FIG. 2A. The fuel source connector 208 may be any known fuel source connector 208 configured to receive fuel from the fuel source 210. The fuel source illustrated in FIGS. 2A and 2B are contained in a fuel cell cartridge 212. The use of a fuel cell cartridge is not intended to be limiting. As illustrated in FIG. 2D, the fuel cell system 200 may be coupled, with a line 250, to a fuel source contained in a box 214. Other types of fuel source containers may also be sued. The type of fuel used is discussed in detail below with reference to FIG. 7A.

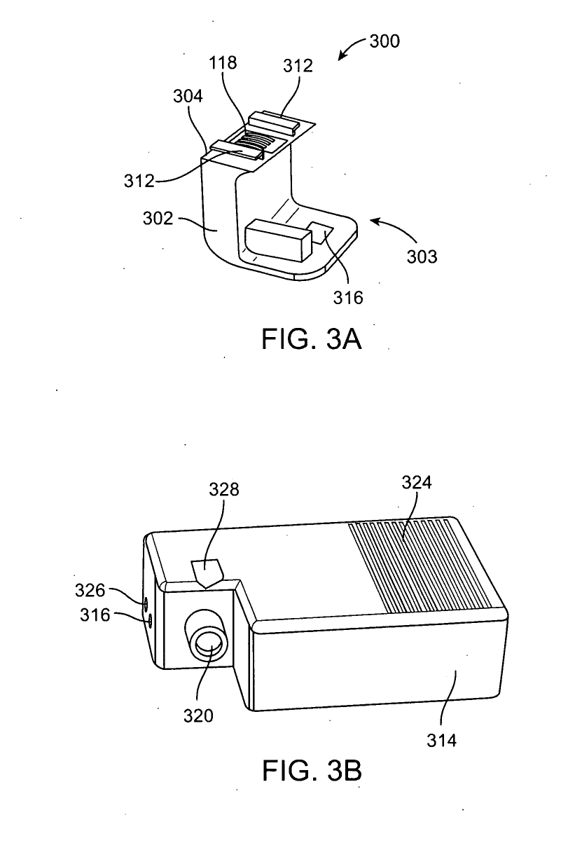

FIGS. 3A and 3B illustrate another embodiment of a power adaptor for use with a portable fuel cell system. Power adaptor 300 is sized, shaped and configured to receive different batteries than the adaptor 100.

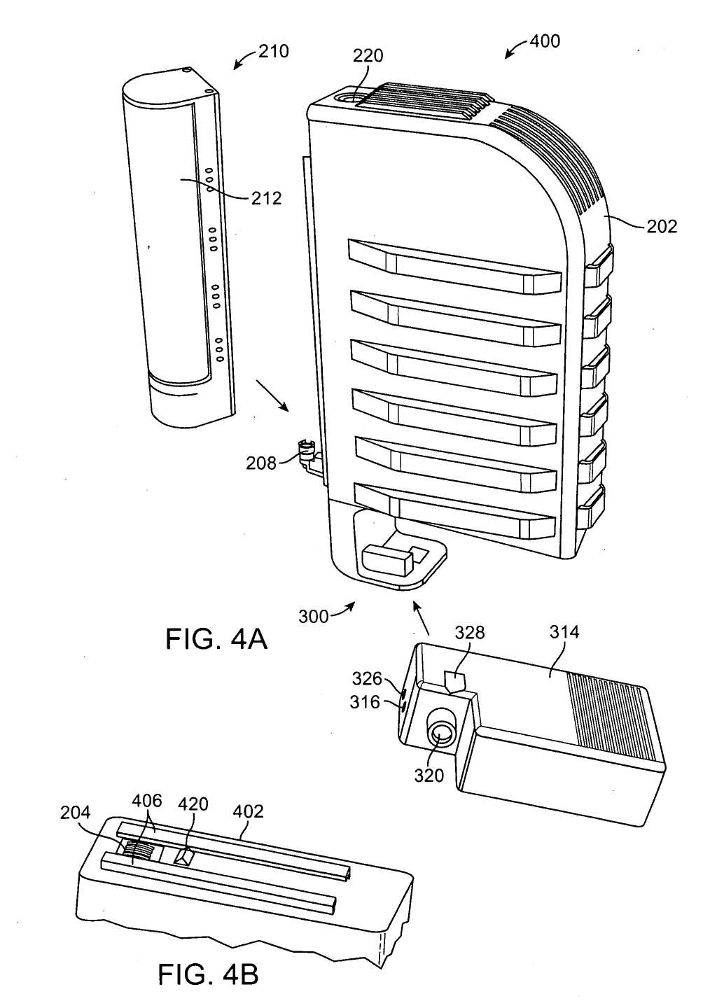

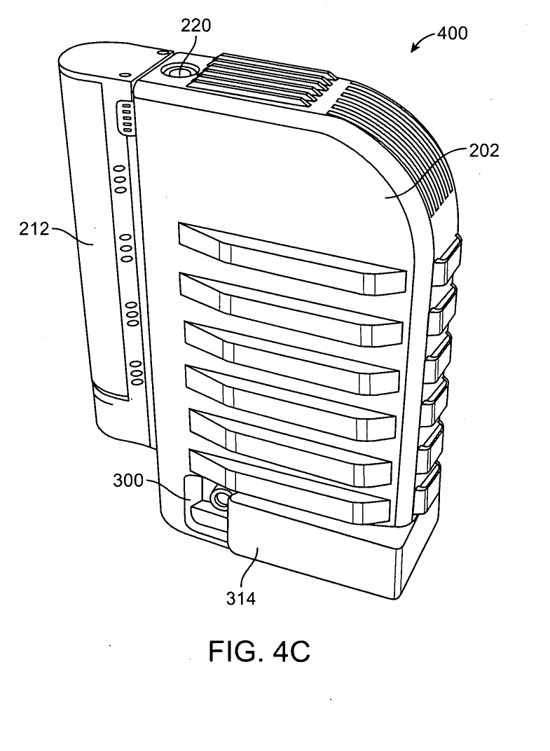

Power adaptor 300 has a power adapter housing 302 with a top surface 304 and a battery receiving region 303. The power adaptor housing 302 may comprise any rigid, durable, and light weight material such as a plastic, metal, and the like. Although illustrated as a separate part from the fuel cell housing 202 (FIG. 4A), it is contemplated that the power adaptor and fuel cell housing may be made as a single molded unit.

Power adaptor 300 also includes electrical contacts 118 on its top surface 304. As described in detail below with reference to FIG. 4A, when the power adapter 300 fully couples to the fuel cell system housing 202 via mechanical connector 312, the electrical contacts 118 are in electrical communication with electrical contacts 204 on the fuel cell system housing 202. Although electrical contact 118 is illustrated as a slide contact, other electrical contacts are contemplated. The contact may be any type of physical interface desired and be any shape, size, or form such as a plug and socket, screw terminals, fast-on or quick-disconnect terminals, universal serial bus connectors, or the like.

The battery receiving region 303 is configured to at least partially receive the battery 314 illustrated in FIG. 3B. Although illustrated with the use of an L150 battery, any other type of battery may be used if it fits the battery receiving region 303. A power source interface 316 may be provided within the battery receiving region 303 of the adapter housing 302. The power source interface 316 is configured to receive the battery 314. The power source interface 316 is in electrical communication with the battery 314 and the electrical contacts 118 of the power adaptor 300. The power source interface 316 may vary based upon the type of battery used. This provides the flexibility for a user to use different batteries with the fuel cell system.

The battery 314 has a mechanical connector 328 to snap-fit securely to a corresponding mechanical connector 420 on the fuel cell system housing 202. Although illustrated as a snap-fit mechanical connector, this is not intended to be limiting as any suitable commercially available or custom mechanical connector may be used to mechanically secure the battery to the fuel cell system housing 202, such as with slideable rails, clips, bolts, adhesives, and the like. Furthermore, although the mechanical connector is illustrated positioned on the top surface 324 of the battery 314, the mechanical connector 328 may be provided in or on any other surface of the battery 314. For example, the battery 314 may have a mechanical connector on the bottom surface (not shown) of the battery 314 to removably couple the battery 314 to the adaptor 300.

Battery 314 includes a data port 326 positioned on a surface of the power adaptor 300. The data port 326 is configured to communicate with a processor 802 (FIG. 8A), as described above with respect to data port 126.

FIGS. 4A-4C illustrate the power adaptor of FIG. 3A in use with a portable fuel cell system. FIG. 4A illustrates the assembly of one embodiment of the fuel cell system, FIG. 4B illustrates the bottom surface of the fuel cell system housing, and FIG. 4C illustrates the fuel cell system of FIG. 4A in an assembled state. As illustrated in FIG. 4B, the fuel cell system housing 202 includes electrical contacts 204 positioned on a surface of the fuel cell system housing 202. The fuel cell housing 202 also has a counterpart mechanical connector 406 configured to receive the mechanical connector 312 on the power adaptor 300.

When the power adapter 300 is coupled to the fuel cell system housing 202 via the mechanical connector 312 and counterpart mechanical connector 406, the electrical contacts 118 on the power adaptor 300 are in electrical communication with the electrical contacts 204 on the fuel cell system housing 202. The battery 314, when coupled to the power adaptor 300, may then supply electrical energy to the fuel cell system 400 via the power source interface 316 and the electrical contacts 118 of the power adapter 300. The power adaptor 300 may be configured to output a constant or variable voltage from the electrical contacts 118 on the power adaptor 300 to the electrical contacts 204 on the fuel cell housing 202.

The fuel cell system 400 includes a fuel source connector 208 coupled to the fuel cell housing 202. The fuel source connector 208 may be any suitable fuel source connector 208 configured to receive the fuel cell cartridge 212 and receive fuel from the fuel source 210. The fuel source connector 208 may be any known or customized connector that allows, for example, the fuel cartridge 212 to snap-fit onto the fuel source connector 208 and be configured to receive fuel from the fuel source 210.

The fuel source illustrated in FIGS. 4A and 4C are contained in a fuel cell cartridge 212. However, as described above, use of a fuel cell cartridge is not intended to be limiting as the fuel may be contained in other containers, such as a high volume bag contained in a box, which uses a line that couples to connector 208.

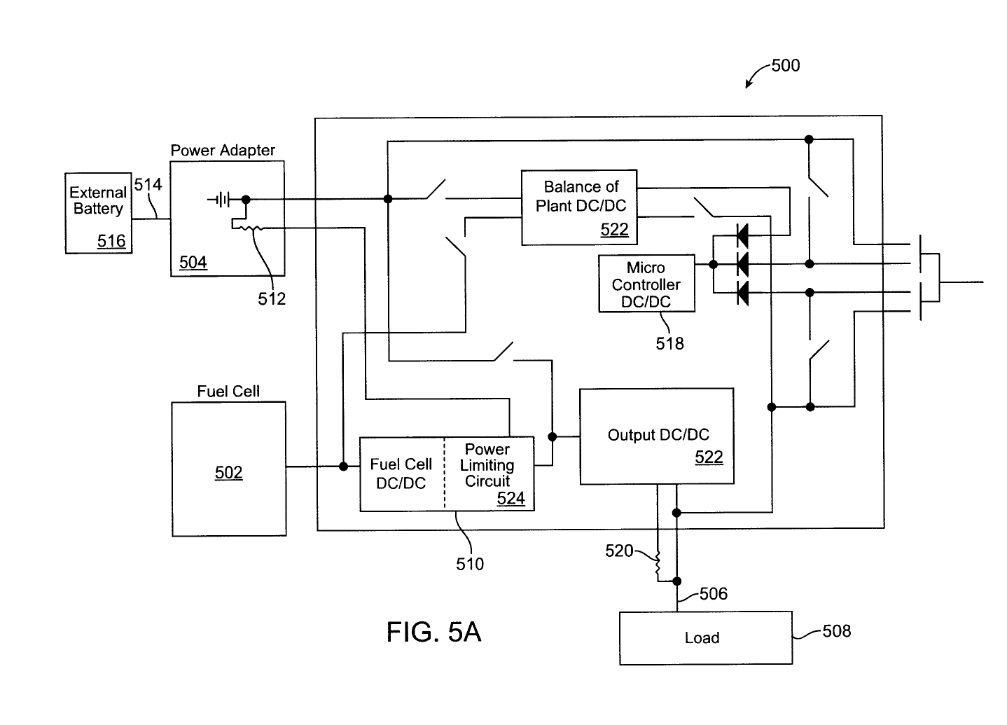

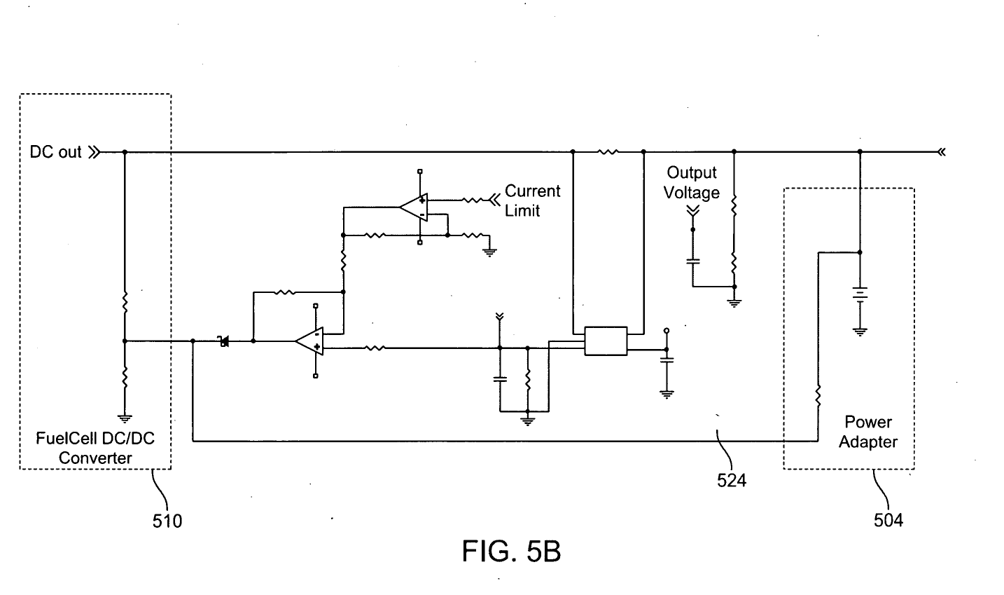

Referring back to FIG. 3B, the battery 314 used to power the fuel cell system 400 may be rechargeable. The battery 314 may have a power input port 316 in electrical communication with a line 514 (FIG. 5) that is also in electrical communication with an external power source 516 (FIG. 5). The battery 314 may even be recharged while attached to the fuel cell system 400. The power supplied via the power input port 316 may be supplied both to the battery 314 for recharging as well as the fuel cell system 400. The battery 314 may also have a power output port 320 to supply power to any other external device. Although the power input port 316 and power output port 320 are illustrated on the battery 314, it is contemplated that a power port may also be positioned on the power adaptor of FIG. 1A to recharge the battery 122, 124 as well as supply power to the fuel cell system 200 and/or an external device.

The electrical contacts 118 on the power adaptor 100, 300 and/or the electrical contacts 204 on fuel cell housing 202 may be exposed, as illustrated, or covered. For example, the electrical contacts may be covered with any known covering that may be removably coupled from the fuel cell housing and/or power adaptor to expose the electrical contacts. Covering the electrical contacts may protect the contacts from damage, contamination, and the like.

The power adaptors described above may allow for the connection and power control of a fuel cell system as well as allow for a battery hybrid system using batteries with different voltages. The shapes of the power adaptor and power source interface are not meant to be limiting as any shape and interface may be used as necessary and/or depending on the battery used. However, the electrical contacts on the fuel cell housing as well as the corresponding electrical contacts on the power adaptor (i.e. 118) should be sufficiently common between adaptors in order to allow different adaptors to commonly connect with the same fuel cell system.

This disclosure also contemplates various mechanisms for electrical performance and control of a fuel cell system that interfaces with a battery and external load. In one embodiment, a power adaptor and power limiting control circuitry allow for the connection and power control of a fuel cell system and different battery hybrid systems (with potentially different batteries and different voltages) that service loads of changing levels

FIGS. 5A and 5B illustrates a simplified electrical diagram of a power flow in the portable fuel cell system in accordance with specific embodiments.

Referring back to FIGS. 2A and 4A, fuel cell housing may have a power port 220. The power port 220 is in electrical communication with a line 506 (FIG. 5) that provides electrical communication between a load 508 and the fuel cell 502. The line may be any tether, wire, cable, or the like able to provide electrical communication between the load 508 and the fuel cell system.

The load 508 receives power from the fuel cell 502 via the power port 220. The load may be require a variable voltage. The load may include a radio, phone, or portable computer, for example. In another embodiment, the load includes a battery that is recharged using power provided by the fuel cell 502. The battery may include battery 516 coupled to the power adaptor.

Fuel cell controller 500 controls the fuel cell 502 power output. The fuel cell controller 500 can output a variable voltage or a constant voltage, as desired by a load 508. In one embodiment, the fuel cell controller 500 has a fuel cell DC/DC converter 510 with power limiting circuitry 524, as further discussed in detail below. In a specific embodiment, the output voltage of the fuel cell DC/DC converter 510 is measured and set with a resistor divider feedback in the fuel cell DC/DC converter 510. A sense voltage of the resistor divider feedback senses the voltage of the battery in the power adaptor 504 which allows for the use of various power adapters with different batteries. Other electrical feedback and control circuits are contemplated.

The power adaptor 504 has a resistor 512 connected in parallel with the resistor divider feedback circuit of the fuel cell DC/DC converter 510 to set the output voltage of the fuel cell DC/DC converter 510. In one embodiment, the output voltage of the fuel cell DC/DC converter 510 is set to the charging voltage of the battery 516 coupled to the power adaptor 504. In another embodiment, the output voltage of the fuel cell DC/DC converter 510 is set to a voltage less than or greater than the charging voltage of the battery 516 in the power adaptor 504. When the fuel cell 502 is operating, the microcontroller 518 monitors the fuel cell 502 power output and provides a voltage to the current limit input.

The power limiting circuit 524 of the fuel cell DC/DC converter 510 provides control of power input and power output of fuel cell 502. In one embodiment, the power limiting control circuit may reside on the output DC/DC converter 522, as opposed to the fuel cell DC/DC converter 510, to reduce the output voltage of the fuel cell 502 and limit power to the load 508.

When the power demand on the fuel cell 502 by external load 508 is less than the fuel cell 502 current limit (e.g., as set by the microcontroller 518), then the output voltage of the fuel cell DC/DC converter 510 remains at the charging voltage of the battery. The fuel cell 502 can then charge the battery 516 in the power adaptor 504, provide power to the external load 508, or both, as long as the power demand by load 508 is less then the current limit for the fuel cell 502 set by the microcontroller 518.

Fuel cells typically have a maximum current limit. When the power demand on the fuel cell 502 by external load 508 surpasses the current limit 518 set by the microcontroller 518, then the output voltage of the fuel cell DC/DC converter 510 may be reduced by injecting current from the battery 516 into the resistor divider feedback circuit of the fuel cell DC/DC converter 510. In other words, reducing the output voltage to load 516 to protect the output power current limit of the fuel cell 502 thus causes the battery to provide current to the load 516 and compensate for the power demand not supplied by the fuel cell 502.

When the power demand by external load 508 subsequently reduces to below the fuel cell 502 current limit (e.g., as set by the microcontroller 518), the output voltage of fuel cell 502 then returns to powering the load 508 and charging the battery 516.

In another embodiment, tether 506 is a voltage selection tether. The voltage selection tether has a resistor 520 that electrically communicates with the resistor divider feedback circuit of the output DC/DC converter 522 to set the output voltage of the output DC/DC converter 522. A wide range of load voltages can be accommodated with a single fuel cell and different voltage selection tethers.

In still another embodiment, the load 508 has a battery. If there is no power adaptor 504 coupled to the fuel cell system, the battery from the load 508 may be used to supply power to the fuel cell system. In one specific embodiment, the battery from the load 508 is used to power the fuel cell during start up. Once the fuel cell system has reached operational conditions, the fuel cell 502 can then supply power to the load 508 and/or recharge the battery in the load 508.

FIG. 5B illustrates a simplified electrical diagram of a power limiting circuitry of the fuel cell DC/DC converter in accordance with another specific embodiment. The fuel cell DC/DC converter 510 has power limiting circuitry 524 in electrical communication with the power adaptor 504. The power adaptor 504 may be coupled to a battery 516 as illustrated in FIG. 5A. In a specific embodiment, the output voltage of the fuel cell DC/DC converter 510 is measured and set with a resistor divider feedback in the fuel cell DC/DC converter 510. A sense voltage of the resistor divider feedback senses the voltage of the battery in the power adaptor 504 which allows for the use of various power adapters with different batteries. Other electrical feedback and control circuits are contemplated.

The power adaptor 504 has a resistor connected in parallel with the resistor divider feedback circuit of the fuel cell DC/DC converter 510 to set the output voltage of the fuel cell DC/DC converter 510. In one embodiment, the output voltage of the fuel cell DC/DC converter 510 is set to the charging voltage of the power adaptor 504. In another embodiment, the output voltage of the fuel cell DC/DC converter 510 is set to a voltage less than or greater than the charging voltage of the power adaptor 504.

The power limiting circuit 524 of the fuel cell DC/DC converter 510 provides control of power input and power output of fuel cell 502. The power limiting circuit 524 senses the power demand on the fuel cell 502 by an external load 508. If the power demand is less than the fuel cell 502 current limit, then the output voltage of the fuel cell DC/DC converter 510 remains at a battery charging voltage. The fuel cell 502 can then charge the battery 516 in the power adaptor 504, provide power to the external load 508, or both, as long as the power demand by load 508 is less then the current limit for the fuel cell 502.

However, fuel cells typically have a maximum current limit. When the power demand on the fuel cell 502 by the external load 508 surpasses the current limit 518, then the output voltage of the fuel cell DC/DC converter 510 may be reduced by injecting current from the power adaptor 504 into the resistor divider feedback circuit of the fuel cell DC/DC converter 510. In other words, reducing the output voltage to load 516 to protect the output power current limit of the fuel cell 502 thus causes the power adaptor 504 to provide current to the load 516 and compensate for the power demand not supplied by the fuel cell 502. When the power demand by the external load 508 subsequently reduces to below the fuel cell 502 current limit, the output voltage of fuel cell 502 then returns to powering the load 508 and charging the battery 516 in the power adaptor 504.

Thus, the power adaptor and power limiting control circuitry may allow for the connection and power control of a fuel cell system as well as allow for different battery hybrid system using different batteries with different voltages.

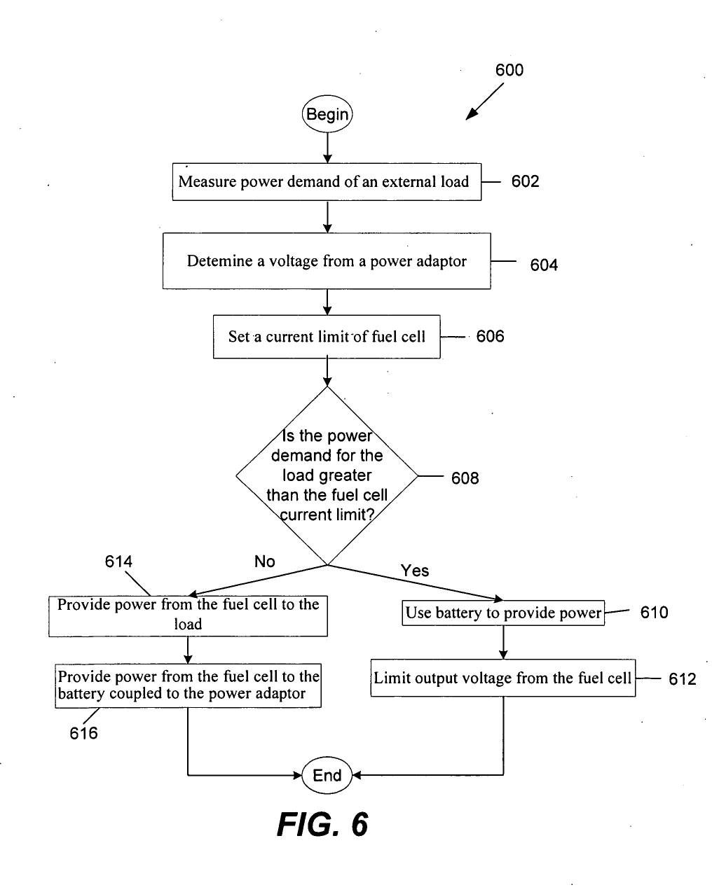

FIG. 6 illustrates a method 600 for regulating power in a portable fuel cell system in accordance with one embodiment. The method 600 measures an output voltage or power demand required by a load at 602. In a specific embodiment, a DC/DC converter coupled to the load determines or measures the power demand. A sensor may also be used to measure demand from the load.

Method 600 then determines the voltage output from a power adaptor at 604 that is in electrical communication with the fuel cell system. Sensing the voltage output from the power adaptor allows for the use of various power adapters with different batteries. In a specific embodiment, the power from the power adaptor is received from a battery as discussed above with reference to FIG. 1A or 3A.

The method 600 then sets the current limit of the fuel cell at 606. The current limit of the fuel cell may be set in a fuel cell DC/DC converter in the fuel cell. In one embodiment, the current limit can be set to the sensed voltage of the power adaptor by a microcontroller in the fuel cell system. In other embodiments, the current limit can be set to a greater than or below the sensed voltage of the power adaptor. In a specific embodiment, the output voltage of the fuel cell DC/DC converter is measured and set with a resistor divider feedback in the fuel cell DC/DC converter.

The method 600 determines whether the power demand for the load is greater than the fuel cell current limit at 608. If the power demand is not greater than the set current limit at 608, the output voltage of the fuel cell DC/DC converter may remain at the charging voltage of the batter coupled to the power adaptor. The fuel cell may provide power to the external load at 614, power to recharge the battery in the power adaptor at 616, or both as long as the power demand is less then the current limit.

The fuel cell DC/DC converter may include power limiting capabilities as described above to limit power input or power output from the fuel cell. Fuel cells typically have a maximum current limit. If the power demand surpasses the current limit set by the fuel cell DC/DC converter at 608, the power adaptor is used to provide power to the load at 610. The output voltage of the fuel cell DC/DC converter may be reduced or limited at 612 by injecting current from the battery coupled to the power adaptor into the resistor divider feedback circuit of the fuel cell DC/DC converter. In other words, reducing the output voltage to the external load to protect the output power current limit of the fuel cell thus causes the battery to provide current to the load and compensate for the power demand not supplied by the fuel cell.

Fuel Cell System Overview

FIGS. 7A-7B illustrate a portable fuel cell system. Fuel cell systems that benefit from embodiments described herein will be described. FIG. 7A illustrates a fuel cell system 10 for producing electrical energy in accordance with one embodiment. As shown, ‘reformed’ hydrogen system 10 includes a fuel processor 15 and fuel cell 20, with a fuel storage device 16 coupled to system 10 for fuel provision. System 10 processes a fuel 17 to produce hydrogen for fuel cell 20. The system may be included in a portable electronics device such as a portable generator, a battery charger, portable computer, a hybrid energy storage device such as a fuel cell/battery combination device, and thus include controls and components to operate the device.

Storage device, or cartridge, 16 stores a fuel 17, and may comprise a refillable and/or disposable device. Either design permits recharging capability for system 10 or an electronics device using the output electrical power by swapping a depleted cartridge for one with fuel. A connector on cartridge 16 interfaces with a mating connector on system 10 or the electronics device to permit fuel transfer from the cartridge. In a specific embodiment, cartridge 16 includes a bladder that contains the fuel 17 and conforms to the volume of fuel in the bladder. An outer rigid housing of device 16 provides mechanical protection for the bladder. The bladder and housing permit a wide range of cartridge sizes with fuel capacities ranging from a few milliliters to several liters. In one embodiment, the cartridge is vented and includes a small hole, single direction flow valve, hydrophobic filter, or other aperture to allow air to enter the fuel cartridge as fuel 17 is consumed and displaced from the cartridge. In another specific embodiment, the cartridge includes ‘smarts’, or a digital memory used to store information related to usage of device 16.

A pressure source moves fuel 17 from storage device 16 to fuel processor 15. In a specific embodiment, a pump in system 10 draws fuel from the storage device. Cartridge 16 may also be pressurized with a pressure source such as compressible foam, spring, or a propellant internal to the housing that pushes on the bladder (e.g., propane, DME, liquid carbon dioxide or compressed nitrogen gas). In this case, a control valve in system 10 regulates fuel flow. Other fuel cartridge designs suitable for use herein may include a wick that moves a liquid fuel from within cartridge 16 to a cartridge exit. If system 10 is load following, then a sensor meters fuel delivery to processor 15, and a control system in communication with the sensor regulates the fuel flow rate as determined by a desired power level output of fuel cell 20.

Fuel 17 acts as a carrier for hydrogen and can be processed or manipulated to separate hydrogen. The terms ‘fuel’, ‘fuel source’ and ‘hydrogen fuel source’ are interchangeable herein and all refer to any fluid (liquid or gas) that can be manipulated to separate hydrogen. Liquid fuels 17 offer high energy densities and the ability to be readily stored and shipped. Fuel 17 may include any hydrogen bearing fuel stream, hydrocarbon fuel or other source of hydrogen such as ammonia. Currently available hydrocarbon fuels 17 suitable for use with system 10 include gasoline, diesel, JP8, JP5, C₁ to C₄ hydrocarbons, their oxygenated analogues and/or their combinations, for example. Other fuel sources may be used with system 10, such as sodium borohydride. Several hydrocarbon and ammonia products may also be used.

Fuel 17 may be stored as a fuel mixture. When the fuel processor 15 comprises a steam reformer, for example, storage device 16 includes a fuel mixture of a hydrocarbon fuel and water. Hydrocarbon fuel/water mixtures are frequently represented as a percentage of fuel in water. In one embodiment, fuel 17 comprises methanol or ethanol concentrations in water in the range of 1-99.9%. Other liquid fuels such as butane, propane, gasoline, military grade “JP8”, etc. may also be contained in storage device 16 with concentrations in water from 5-100%. In a specific embodiment, fuel 17 comprises 67% methanol by volume. In another specific embodiment, fuel 17 comprises pure methanol.

Fuel processor 15 receives methanol 17 and outputs hydrogen. In one embodiment, a hydrocarbon fuel processor 15 heats and processes a hydrocarbon fuel 17 in the presence of a catalyst to produce hydrogen. Fuel processor 15 comprises a reformer, which is a catalytic device that converts a liquid or gaseous hydrocarbon fuel 17 into hydrogen and carbon dioxide. Those of skill in the art will understand that the fuel may be mixed with air in a catalytic partial oxidizer (CPDX), or additional steam added and the reactants fed into an auto thermal reformer (ATR). As the term is used herein, reforming refers to the process of producing hydrogen from a fuel 17. Fuel processor 15 may output either pure hydrogen or a hydrogen-bearing gas stream (also commonly referred to as ‘reformate’).

Various types of reformers are suitable for use in fuel cell system 10; these include steam reformers, auto thermal reformers (ATR) and catalytic partial oxidizers (CPDX) for example. A steam reformer only needs steam and fuel to produce hydrogen. ATR and CPDX reformers mix air with a fuel/steam mixture. ATR and CPDX systems reform fuels such as methanol, diesel, regular unleaded gasoline and other hydrocarbons. In a specific embodiment, storage device 16 provides methanol 17 to fuel processor 15, which reforms the methanol at about 280 degrees Celsius or less and allows fuel cell system 10 usage in low temperature applications.

Fuel cell 20 electrochemically converts hydrogen and oxygen to water, generating electrical energy (and sometimes heat) in the process. Ambient air readily supplies oxygen. A pure or direct oxygen source may also be used. The water often forms as a vapor, depending on the temperature of fuel cell 20. For some fuel cells, the electrochemical reaction may also produce carbon dioxide as a byproduct. As described above with reference to FIG. 5, the electrical energy may be transmitted to a power adaptor 50 to recharge a battery housed within the power adaptor 50.

In one embodiment, fuel cell 20 is a low volume ion conductive membrane (PEM) fuel cell suitable for use with portable applications and consumer electronics. A PEM fuel cell comprises a membrane electrode assembly (MEA) that carries out the electrical energy generating an electrochemical reaction. The MEA includes a hydrogen catalyst, an oxygen catalyst, and an ion conductive membrane that a) selectively conducts protons and b) electrically isolates the hydrogen catalyst from the oxygen catalyst. One suitable MEA is model number CELTEC P1000 as provided by BASF Fuel Cells of Frankfurt, Germany. A hydrogen gas distribution layer may also be included; it contains the hydrogen catalyst and allows the diffusion of hydrogen therethrough. An oxygen gas distribution layer contains the oxygen catalyst and allows the diffusion of oxygen and hydrogen protons therethrough. Typically, the ion conductive membrane separates the hydrogen and oxygen gas distribution layers. In chemical terms, the anode comprises the hydrogen gas distribution layer and hydrogen catalyst, while the cathode comprises the oxygen gas distribution layer and oxygen catalyst.

In one embodiment, a PEM fuel cell includes a fuel cell stack having a set of bi-polar plates. In a specific embodiment, each bi-polar plate is formed from a thin single sheet of metal that includes channel fields on opposite surfaces of the metal sheet. Thickness for these plates is typically below about 5 millimeters, and compact fuel cells for portable applications may employ plates thinner than about 2 millimeters. In a specific embodiment, the thickness of the bi-polar plate is less that 0.5 millimeters. The single bi-polar plate thus dually distributes hydrogen and oxygen; one channel field distributes hydrogen while a channel field on the opposite surface distributes oxygen. In another embodiment, each bi-polar plate is formed from multiple layers that include more than one sheet of metal. Multiple bi-polar plates can be stacked to produce the ‘fuel cell stack’ in which a membrane electrode assembly is disposed between each pair of adjacent bi-polar plates. Gaseous hydrogen distribution to the hydrogen gas distribution layer in the MEA occurs via a channel field on one plate while oxygen distribution to the oxygen gas distribution layer in the MES occurs via a channel field on a second plate on the other surface of the membrane electrode assembly.

In electrical terms, the anode includes the hydrogen gas distribution layer, hydrogen catalyst and a bi-polar plate. The anode acts as the negative electrode for fuel cell 20 and conducts electrons that are freed from hydrogen molecules so that they can be used externally, e.g., to power an external circuit or stored in a battery. In electrical terms, the cathode includes the oxygen gas distribution layer, oxygen catalyst and an adjacent bi-polar plate. The cathode represents the positive electrode for fuel cell 20 and conducts the electrons back from the external electrical circuit to the oxygen catalyst, where they can recombine with hydrogen ions and oxygen to form water.

In a fuel cell stack, the assembled bi-polar plates are connected in series to add electrical potential gained in each layer of the stack. The term ‘bi-polar’ refers electrically to a bi-polar plate (whether mechanically comprised of one plate or two plates) sandwiched between two membrane electrode assembly layers. In a stack where plates are connected in series, a bi-polar plate acts as both a negative terminal for one adjacent (e.g., above) membrane electrode assembly and a positive terminal for a second adjacent (e.g., below) membrane electrode assembly arranged on the opposite surface of the bi-polar plate.

In a PEM fuel cell, the hydrogen catalyst separates the hydrogen into protons and electrons. The ion conductive membrane blocks the electrons, and electrically isolates the chemical anode (hydrogen gas distribution layer and hydrogen catalyst) from the chemical cathode. The ion conductive membrane also selectively conducts positively charged ions. Electrically, the anode conducts electrons to a load (electrical energy is produced) or battery (energy is stored). Meanwhile, protons move through the ion conductive membrane. The protons and used electrons subsequently meet on the cathode side, and combine with oxygen to form water. The oxygen catalyst in the oxygen gas distribution layer facilitates this reaction. One common oxygen catalyst comprises platinum powder thinly coated onto a carbon paper or cloth. Many designs employ a rough and porous catalyst to increase surface area of the platinum exposed to the hydrogen and oxygen. A fuel cell suitable for use herein is further described in commonly owned patent application Ser. No. 11/120,643, entitled “Compact Fuel Cell Package”, filed May 2, 2005, which is incorporated by reference in its entirety for all purposes.

Since the electrical generation process in fuel cell 20 is exothermic, fuel cell 20 may implement a thermal management system to dissipate heat. Fuel cell 20 may also employ a number of humidification plates (HP) to manage moisture levels in the fuel cell.

While system 10 will mainly be discussed with respect to PEM fuel cells, it is understood that system 10 may be practiced with other fuel cell architectures. The main difference between fuel cell architectures is the type of ion conductive membrane used. In another embodiment, fuel cell 20 is phosphoric acid fuel cell that employs liquid phosphoric acid for ion exchange. Solid oxide fuel cells employ a hard, non-porous ceramic compound for ion exchange and may be suitable for use with embodiments described herein. Other suitable fuel cell architectures may include alkaline and molten carbonate fuel cells, for example.

In one embodiment, fuel cell system 10 may have an onboard control board 300 that includes a processor system with a processor 19 and memory 21. Processor 19 and memory 21 may be cumulatively referred to as a processing system.

Processor 19, or controller 19, is designed or configured to execute one or more software applications that control one or more components in system 10. In addition, processing system 19 may be designed or configured to execute software applications that allow control one or more components in system. Processor 19 may include any commercially available logic device known to those of skill in the art. For example, processor 19 may include a commercially available microprocessor such as one of the Intel or Motorola family of chips or chipsets, or another suitable commercially available processor. Processor 19 may digitally communicate with memory 21 via a system bus, which may comprise a data bus, control bus, and address bus for communication between processor 19 and memory 21.

Memory 21 also stores logic and control schemes for methods describer herein. The logic and control schemes may be encoded in one or more tangible media for execution and, when executed, operable to validate a cartridge 16 or operate a fuel cell system. In one embodiment, the fuel cell system methods are automated. A user may initiate system operation by turning on a power button for the system, and all steps are automated until power production begins. Because such information and program instructions may be employed to implement the systems/methods described herein, the present invention relates to machine-readable media that include program instructions, state information, etc. for performing various operations described herein. Examples of tangible machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter. The invention may also be embodied in a carrier wave traveling over an appropriate medium such as airwaves, optical lines, electric lines, etc.

Power adaptor 50 may also have a processor 702 and a memory 704 as was described above. A data port 126 on the power adaptor 50 may be configured to communicate with processor 702. The processor 702 may have at least one power management controller configured to i) determine an amount of power to be provided to the fuel cell system and a power output of the battery; ii) obtain and provide information about the battery; iii) detect the operational state of the fuel cell system, or provide any other user functions or information. The processor 702 may be in communication with a memory 704 storing a software application operable to provide information concerning the battery and the fuel cell system to a computing device (further discussed with reference to FIGS. 8A and 8B) via the data port 126. The software application may allow the user to receive information about the battery and/or fuel cell system as well as control the power input and output from the battery, fuel cell system 200, and/or an external power source via the power management controller.

FIG. 7B illustrates a schematic operation for the fuel cell system 10 of FIG. 7A. Fuel cell system 10 is included in a portable package 11. In this case, package 11 includes fuel cell 20, fuel processor 15, and all other balance-of-plant (BOP) components except cartridge 16. As the term is used herein, a fuel cell system package 11 refers to a fuel cell system that receives a fuel and outputs electrical energy. At a minimum, this includes a fuel cell and fuel processor. The package need not include a cover or housing, e.g., in the case where a fuel cell, or a fuel cell and fuel processor, is included in a battery bay of a laptop computer. In this case, the portable fuel cell system package 11 only includes the fuel cell, or fuel cell and fuel processor, and no housing. The package may include a compact profile, low volume, or low mass—any of which is useful in any power application where size is relevant.

Package 11 is divided into two parts: a) an engine block 12 and b) all other parts and components of system 10 in the portable package 11 not included in engine block 12. In one embodiment, engine block 12 includes the core power-producing mechanical components of system 10. At a minimum, this includes fuel processor 15 and fuel cell 20. It may also include any plumbing configured to transport fluids between the two. Other system components included in engine block 12 may include: one or more sensors for fuel processor 15 and fuel cell 20, a glow plug or electrical heater for fuel heating in fuel processor during start-up, and/or one or more cooling components. Engine block 12 may include other system components. Components outside of engine block 12 may include: a body for the package, connector 23, inlet and outlet plumbing for system fluids to or from fuel processor 15 or fuel cell 20, one or more compressors or fans, electronic controls, system pumps and valves, any system sensors, manifolds, heat exchangers and electrical interconnects useful for carrying out functionality of fuel cell system 10.

In one embodiment, the engine block 12 includes a fuel cell, a fuel processor, and dedicated mechanical and fluidic connectivity between the two. The dedicated connectivity may provide a) fluid or gas communication between the fuel processor and the fuel cell, and/or b) structural support between the two or for the package. In one embodiment, an interconnect, which is a separate device dedicated to interconnecting the two devices, provides much of the connectivity. In another embodiment, direct and dedicated connectivity is provided on the fuel cell and/or fuel processor to interface with the other. For example, a fuel cell may be designed to interface with a particular fuel processor and includes dedicated connectivity for that fuel processor. Alternatively, a fuel processor may be designed to interface with a particular fuel cell. Assembling the fuel processor and fuel cell together in a common and substantially enclosed package 11 provides a portable ‘black box’ device that receives a fuel and outputs electrical energy.

In one embodiment, system 10 is sold as a physical engine block 12 plus specifications for interfacing with the engine block 12. The specifications may include desired cooling rates, airflow rates, physical sizing, heat capture and release information, plumbing specifications, fuel inlet parameters such as the fuel type, mixture and flow rates, etc. This permits engine block 12 to be sold as a core component employed in a wide variety of devices determined by the engine block purchaser. Sample devices include: portable fuel cell systems, consumer electronics components, single or ganged battery chargers for portable radios such as laptop computers, and custom electronics devices.

Fuel storage device 16 stores methanol or a methanol mixture as a hydrogen fuel 17. An outlet of storage device 16 includes a connector 23 that couples to a mating connector on package 11. In a specific embodiment, connector 23 and mating connector form a quick connect/disconnect for easy replacement of cartridges 16. The mating connector communicates methanol 17 into hydrogen fuel line 25, which is internal to package 11.

Line 25 divides into two lines: a first line 27 that transports methanol 17 to a burner/heater 30 for fuel processor 15 and a second line 29 that transports methanol 17 for a reformer 32 in fuel processor 15. Lines 25, 27 and 29 may comprise channels disposed in the fuel processor (e.g., channels in one or more metal components) and/or tubes leading thereto.

As the term is used herein, a line refers to one or more conduits or channels that communicate a fluid (a gas, liquid, or combination thereof). For example, a line may include a separable plastic conduit. In a specific embodiment to reduce package size, the fuel cell and the fuel processor may each include a molded channel dedicated to the delivering hydrogen from the processor to the cell. The channeling may be included in a structure for each. When the fuel cell attaches directly to the fuel processor, the hydrogen transport line then includes a) channeling in the fuel processor to deliver hydrogen from a reformer to the connection, and b) channeling in the fuel cell to deliver the hydrogen from the connection to a hydrogen intake manifold. An interconnect may also facilitate connection between the fuel cell and the fuel processor. The interconnect includes an integrated hydrogen conduit dedicated to hydrogen transfer from the fuel processor to the fuel cell. Other plumbing techniques known to those of skill in the art may be used to transport fluids in a line.

Flow control is provided on each line 27 and 29. In this embodiment, separate pumps 21a and 21b are provided for lines 27 and 29, respectively, to pressurize each line separately and transfer methanol at independent rates, if desired. A model 030SP-S6112 pump as provided by Biochem, NJ is suitable to transmit liquid methanol on either line in a specific embodiment. A peristaltic, electro-osmotic, diaphragm or piezoelectric pump is also suitable for use with system 10. A flow restriction may also be provided on each line 27 and 29 to facilitate sensor feedback and flow rate control. In conjunction with suitable control, such as digital control applied by a processor that implements instructions from stored software, each pump 21 responds to control signals from the processor and moves a desired amount of methanol 17 from storage device 16 to heater 30 and reformer 32 on each line 27 and 29.

Air source 41 delivers oxygen and air from the ambient room through line 31 to the cathode in fuel cell 20, where some oxygen is used in the cathode to generate electricity. Air source 41 may include a pump, fan, blower, or compressor, for example.

High operating temperatures in fuel cell 20 also heat the oxygen and air. In the embodiment shown, the heated oxygen and air is then transmitted from the fuel cell, via line 33, to a regenerator 36 (also referred to herein as a ‘dewar’) of fuel processor 15, where the air is additionally heated (by escaping heat from heater 30) before the air enters heater 30. This double pre-heating increases efficiency of fuel cell system 10 by a) reducing heat lost to reactants in heater 30 (such as fresh oxygen that would otherwise be near room temperature when combusted in the heater), and b) cooling the fuel cell during energy production. In a specific embodiment, a model BTC compressor as provided by Hargraves, N.C. is suitable to pressurize oxygen and air for fuel cell system 10. Other air moving devices such as fans, blowers, gerotor compressors etc are also suitable.

When fuel cell cooling is needed, a fan 37 blows air from the ambient room over fuel cell 20. Fan 37 may be suitably sized to move air as desired by the heating requirements of fuel cell 20; many vendors known to those of skill in the art provide fans and blowers suitable for use with package 10.

Fuel processor 15 is configured to process fuel 17 and output hydrogen. Fuel processor 15 comprises heater 30, reformer 32, boiler 34, and regenerator 36. Heater 30 (also referred to herein as a burner when it uses catalytic combustion to generate heat) includes an inlet that receives methanol 17 from line 27. In a specific embodiment, the burner includes a catalyst that helps generate heat from methanol, such as platinum or palladium coated onto a suitable support or alumina pellets for example.

In a specific embodiment, heater 30 includes its own boiler to preheat fuel for the heater. Boiler 34 includes a chamber having an inlet that receives methanol 17 from line 29. The boiler chamber is configured to receive heat from heater 30, via heat conduction through one or more walls between the boiler 34 and heater 30, and use the heat to boil the methanol passing through the boiler chamber. The structure of boiler 34 permits heat produced in heater 30 to heat methanol 17 in boiler 34 before reformer 32 receives the methanol 17. In a specific embodiment, the boiler chamber is sized to boil methanol before receipt by reformer 32. Boiler 34 includes an outlet that provides heated methanol 17 to reformer 32.

Reformer 32 includes an inlet that receives heated methanol 17 from boiler 34. A catalyst in reformer 32 reacts with the methanol 17 to produce hydrogen and carbon dioxide; this reaction is endothermic and draws heat from heater 30. A hydrogen outlet of reformer 32 outputs hydrogen to line 39. In one embodiment, fuel processor 15 also includes a preferential oxidizer that intercepts reformer 32 hydrogen exhaust and decreases the amount of carbon monoxide in the exhaust. The preferential oxidizer employs oxygen from an air inlet to the preferential oxidizer and a catalyst, such as ruthenium that is preferential to carbon monoxide over hydrogen.

Regenerator 36 pre-heats incoming air before the air enters heater 30. In one sense, regenerator 36 uses outward traveling waste heat in fuel processor 15 to increase thermal management and thermal efficiency of the fuel processor. Specifically, waste heat from heater 30 pre-heats incoming air provided to heater 30 to reduce heat transfer to the air within the heater. As a result, more heat transfers from the heater to reformer 32. The regenerator also functions as insulation. More specifically, by reducing the overall amount of heat loss from fuel processor 15, regenerator 36 also reduces heat loss from package 11. This enables a cooler fuel cell system 10 package.

In one embodiment, fuel processor 15 includes a monolithic structure having common walls between the heater 30 and other chambers in the fuel processor. Fuel processors suitable for use herein are further described in commonly owned patent application Ser. No. 10/877,044, entitled “Annular Fuel Processor And Methods”, filed Jun. 25, 2004, which is incorporated by reference in its entirety for all purposes.

Line 39 transports hydrogen (or ‘reformate’) from fuel processor 15 to fuel cell 20. In a specific embodiment, gaseous delivery lines 33, 35 and 39 include channels in a metal interconnect that couples to both fuel processor 15 and fuel cell 20. A hydrogen flow sensor (not shown) may also be added on line 39 to detect and communicate the amount of hydrogen being delivered to fuel cell 20. In conjunction with the hydrogen flow sensor and suitable control, such as digital control applied by a processor that implements instructions from stored software, system 10 regulates hydrogen gas provision to fuel cell 20.

Fuel cell 20 includes a hydrogen inlet port that receives hydrogen from line 39 and includes a hydrogen intake manifold that delivers the gas to one or more bi-polar plates and their hydrogen distribution channels. An oxygen inlet port of fuel cell 20 receives oxygen from line 31; an oxygen intake manifold receives the oxygen from the port and delivers the oxygen to one or more bi-polar plates and their oxygen distribution channels. A cathode exhaust manifold collects gases from the oxygen distribution channels and delivers them to a cathode exhaust port and line 33, or to the ambient room. An anode exhaust manifold 38 collects gases from the hydrogen distribution channels, and in one embodiment, delivers the gases to the ambient room.

In a specific embodiment, and as shown, the anode exhaust is transferred back to fuel processor 15. In this case, system 10 comprises plumbing 38 that transports unused hydrogen from the anode exhaust to heater 30. For system 10, heater 30 includes two inlets: an inlet configured to receive fuel 17 and an inlet configured to receive hydrogen from line 38. Heater 30 then includes a thermal catalyst that reacts with the unused hydrogen to produce heat. Since hydrogen consumption within a PEM fuel cell 20 is often incomplete and the anode exhaust often includes unused hydrogen, re-routing the anode exhaust to heater 30 allows a fuel cell system to capitalize on unused hydrogen and increase hydrogen usage and energy efficiency. The fuel cell system thus provides flexibility to use different fuels in a catalytic heater 30. For example, if fuel cell 20 can reliably and efficiently consume over 90% of the hydrogen in the anode stream, then there may not be sufficient hydrogen to maintain reformer and boiler operating temperatures in fuel processor 15. Under this circumstance, methanol supply is increased to produce additional heat to maintain the reformer and boiler temperatures. In one embodiment, gaseous delivery in line 38 back to fuel processor 15 relies on pressure at the exhaust of the anode gas distribution channels, e.g., in the anode exhaust manifold. In another embodiment, an anode recycling pump or fan is added to line 38 to pressurize the line and return unused hydrogen back to fuel processor 15. The unused hydrogen is then combusted for heat generation.

In one embodiment, fuel cell 20 includes one or more heat transfer appendages 46 that permit conductive heat transfer with internal portions of a fuel cell stack. This may be done for heating and/or cooling fuel cell 20. In a specific heating embodiment, exhaust 35 of heater 30 is transported to the one or more heat transfer appendages 46 during system start-up to expedite reaching initial elevated operating temperatures in fuel cell 20. The heat may come from hot exhaust gases or unburned fuel in the exhaust, which then interacts with a catalyst disposed on or in proximity with a heat transfer appendage 46. In a specific cooling embodiment, fan 37 blows cooling air over the one or more heat transfer appendages 46, which provides dedicated and controllable cooling of the stack during electrical energy production. Fuel cells suitable for use herein are further described in commonly owned patent application Ser. No. 10/877,770, entitled “Micro Fuel Cell Thermal Management”, filed Jun. 25, 2004, which is incorporated by reference in its entirety for all purposes.

In one embodiment, system 10 increases thermal and overall energy efficiency of a portable fuel cell system by using waste heat in the system to heat incoming reactants such as an incoming fuel or air. To this end, the embodiment in FIG. 7B includes heat exchanger, or recuperator 42.

Heat exchanger 42 transfers heat from fuel cell system 10 to the inlet fuel 17 before the methanol reaches fuel processor 15. This increases thermal efficiency for system 10 by preheating the incoming fuel (to reduce heating of the fuel in heater 30) and reuses heat that would otherwise be expended from the system. While system 10 shows heat exchanger 42 heating methanol in line 29 that carries fuel 17 to the boiler 34 and reformer 32, it is understood that heat exchanger 42 may be used to heat methanol in line 27 that carries fuel 17 to burner 30.

Heat exchanger 42 may include any device configured to transfer heat produced in fuel cell system 10, or from a fluid heated in fuel cell system 10 and used as a carrier of the heat, to an incoming reactant such as fuel 17 or air. Heat exchanger 42 may rely on conductive heat transfer, convective heat transfer, and combinations thereof. Heat exchanger 42 may include one or more heat transfer channels for moving the incoming fuel 17, moving the heating medium, and one or more surfaces or structures for transferring heat from the heating medium to the incoming fuel 17. In one embodiment, heat exchanger 42 includes a commercially available heat exchanger. In another embodiment, heat exchanger 42 is a custom made device according to a user's specification.

In addition to the components shown in shown in FIG. 7B, system 10 may also include other elements such as electronic controls, additional pumps and valves, added system sensors, manifolds, heat exchangers and electrical interconnects useful for carrying out functionality of a fuel cell system 10 that are known to one of skill in the art and omitted for sake of brevity. FIG. 7B shows one specific plumbing arrangement for a fuel cell system; other plumbing arrangements are suitable for use herein. For example, the heat transfer appendages 46, a heat exchanger and dewar 36 need not be included. Other alterations to system 10 are permissible, as one of skill in the art will appreciate.

System 10 generates dc voltage, and is suitable for use in a wide variety of portable applications. For example, electrical energy generated by fuel cell 20 may power a notebook computer 11 or a portable electrical generator 11 carried by military personnel.

In one embodiment, system 10 provides portable, or ‘small’, fuel cell systems that are configured to output less than 200 watts of power (net or total). Fuel cell systems of this size are commonly referred to as ‘micro fuel cell systems’ and are well suited for use with portable electronics devices. In one embodiment, the fuel cell is configured to generate from about 1 milliwatt to about 200 Watts. In another embodiment, the fuel cell generates from about 5 Watts to about 60 Watts. Fuel cell system 10 may be a stand-alone system, which is a single package 11 that produces power as long as it has access to a) oxygen and b) hydrogen or a fuel such as a hydrocarbon fuel. One specific portable fuel cell package produces about 20 Watts or about 45 Watts, depending on the number of cells in a stack for fuel cell 20 and the amount of catalyst in the fuel processor reformer and burner reactors.

In addition to power capacity, portable fuel cell system 10 may also be characterized by its size or power density. Volume may characterize package 11, where the volume includes all components of the package 11 used in system 10, save the external storage device 16, whose size may change. In a specific embodiment, package 11 has a total volume less than about a liter. In a specific embodiment, package 11 has a total volume less than about ½ liter. Greater and lesser package volumes may be used with system 10.

Portable package 11 also includes a relatively small mass. In one embodiment, package 11 has a total mass less than about a 1 kilogram. In a specific embodiment, package 11 has a total volume less than about ½ liter. Greater and lesser package masses are permissible.

Power density may also be used to characterize system 10 or package 11. Power density refers to the ratio of electrical power output provided by a fuel cell system included relative to a physical parameter such as volume or mass of package 11. Notably, fuel cell systems described herein provide fuel cell packages with power densities not yet attained in the fuel cell industry. In one embodiment, fuel cell package 11 provides a power density of greater than about 40 Watts/liter. This package includes all balance of plant (BOP) items (cooling system, power conversion, start-up battery, etc.) except the fuel and fuel source storage device 16, which may be controlled by BOP DC/DC 522 (FIG. 5). In another specific embodiment, fuel cell package 11 provides a power density of greater than about 80 Watts/liter. A power density from about 45 Watts/liter to about 90 Watts/liter works well for many portable applications. Greater and lesser power densities are also permissible.

FIG. 8 illustrate a computer system, which is suitable for implementing the software applications used in one or more embodiments of the present disclosure. FIG. 8 shows one possible physical form of the computer system 800 stored within the fuel cell system. Of course, the computer system may have many physical forms ranging from an integrated circuit, a printed circuit board, or the like.

Attached to system bus 820 is a wide variety of subsystems. Processor(s) 822 (also referred to as central processing units, controller, CPUs, or the like) are coupled to storage devices, including memory 824. Memory 824 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 826 is also coupled bi-directionally to CPU 822; it provides additional data storage capacity and may also include any of the computer-readable media described below. Fixed disk 826 may be used to store programs, data, and the like and is typically a secondary storage medium (such as a hard disk) that is slower than primary storage. It will be appreciated that the information retained within fixed disk 826 may, in appropriate cases, be incorporated in standard fashion as virtual memory in memory 824.

CPU 822 is also coupled to a variety of input/output devices, such as display 804, speakers 880, power adaptor 810, external load 812, and the like.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level of code that are executed by a computer using an interpreter. Computer readable media may also be computer code transmitted by a computer data signal embodied in a carrier wave and representing a sequence of instructions that are executable by a processor.

While embodiments and applications of this invention have been shown and described, it would be apparent to those skilled in the art having the benefit of this disclosure that many more modifications than mentioned above are possible without departing from the inventive concepts herein.

What is claimed is:

1. A power adaptor for use with a portable fuel cell system, the fuel cell system having a fuel cell system housing, the power adaptor comprising:
an adapter housing having at least one external surface and a battery receiving region, the battery receiving region configured to at least partially receive a battery;
a first set of electrical contacts provided on the at least one external surface of the adapter housing;
a power source interface provided within the battery receiving region of the adapter housing, the power source interface in electrical communication with the first set of electrical contacts; and
at least one mechanical connector provided in or on the adapter housing to facilitate detachable attachment of the adapter housing to the fuel cell system housing.

2. The power adaptor of claim 1, wherein the fuel cell system housing includes a second set of electrical contacts and at least one counterpart mechanical connector, and
wherein when the power adapter is attached to the fuel cell system housing via the at least one mechanical connector and the at least one counterpart mechanical connector, the first set of electrical contacts are in electrical communication with the second set of electrical contacts of the fuel cell system housing.

3. The power adaptor of claim 1, wherein the battery is in electrical communication with the power source interface when positioned in the battery receiving region.

4. The power adaptor of claim 1, wherein the battery is electrically configured to supply electrical energy to the fuel cell system via the power source interface and the first set of electrical contacts of the power adapter.

5. The power adaptor of claim 1, wherein the battery is a rechargeable battery.

6. The power adaptor of claim 5, wherein the battery is recharged while attached to the fuel cell system.

7. The power adaptor of claim 1, further comprising a power port in electrical communication with a line that is in electrical communication with an external power source and the battery.

8. The power adaptor of claim 7, wherein power supplied via the power port is supplied to the fuel cell system.

9. The power adaptor of claim 1, wherein the power adaptor is configured to output a variable voltage at the first set of electrical contacts.

10. The power adaptor of claim 1, further comprising:
a processor having:
at least one power management controller configured to i) determine an amount of power to be provided to the fuel cell system and a power output of the battery; ii) obtain and provide information about the battery; and iii) detect the operational state of the fuel cell system.

11. The power adaptor of claim 1, further comprising a data port.

12. The power adaptor of claim 11, further comprising:
a memory storing a software application,
wherein the software application is operable to provide information concerning the battery and the fuel cell system to a computing device via the data port.

13. The power adaptor of claim 12, wherein the software application allows the user to control the power output from the battery and power to the fuel cell system via the power management controller.

14. A fuel cell system, comprising:
a fuel cell system housing;
a fuel cell within the fuel cell system housing including a fuel cell stack configured to produce electrical energy using hydrogen output by the fuel processor;
a first set of electrical contacts positioned on an external surface of the fuel cell system housing;
a fuel source connector configured to receive the fuel source, the fuel source connector coupled to a first external portion of the fuel cell system housing; and
a first power adaptor for detachably coupling to a second external portion of the fuel cell housing, the power adaptor including i) a second set of electrical contacts configured to be in electrical communication with the first set of electrical contacts when the power adaptor is detachably coupled to the fuel cell system housing; ii) a first mechanical connector configured to detachably couple the first power adaptor to the external surface of the fuel cell system housing; and iii) a first battery receiver configured to receive a first battery, the first battery receiver having a third set of electrical contacts in electrical communication with the second set of electrical contacts and in electrical communication with the first battery when the first battery is detachably coupled to the first power adaptor.
a second power adaptor for detachably coupling to the second external portion of the fuel cell housing, the second power adaptor including i) a fourth set of electrical contacts configured to be in electrical communication with the first set of electrical contacts when the power adaptor is detachably coupled to the fuel cell system housing; ii) a second mechanical connector configured to detachably couple the second power adaptor to the external surface of the fuel cell system housing; and iii) a second battery receiver configured to receive a second battery, the second battery receiver having a fifth set of electrical contacts in electrical communication with the fourth set of electrical contacts and in electrical communication with the second battery when the second battery is detachably coupled to the second power adaptor.

15. The system of claim 14, wherein the second set of electrical contacts and the fourth set of electrical contacts are substantially similar.

16. The system of claim 14, wherein there is no battery within the fuel cell system housing.

17. The system of claim 14, wherein the first battery and the second battery each comprise a power port in electrical communication with a line that is in electrical communication with an external power source.

18. The system of claim 14, wherein the first battery and the second battery is a rechargeable battery.

19. The system of claim 14, wherein the first power adaptor is configured to output a variable voltage at the second set of electrical contacts and the second power adaptor is configured to output a variable voltage at the fourth set of electrical contacts.

20. The system of claim 14, wherein the first power adaptor and the second power adaptor each comprise:
a processor having:
at least one power management controller configured to i) determine an amount of power to be provided to by the fuel cell system and a power output of the battery, ii) obtain and provide information about the battery; and iii) detect the operational state of the fuel cell system.

21. The system of claim 14, wherein the first power adaptor and the second power adaptor each comprise a data port.

22. The system of claim 14, wherein the first power adaptor further comprises a first power port in electrical communication with a line that is in electrical communication with an external power source and the first battery.

23. The system of claim 22, wherein power supplied via the first power port is supplied to the fuel cell system.

24. The system of claim 14, wherein the second power adaptor further comprises a second power port in electrical communication with a line that is in electrical communication with an external power source and the second battery.

25. The system of claim 24, wherein power supplied via the second power port is supplied to the fuel cell system.

26. The system of claim 14, wherein the fuel cell system housing further comprises at least one vent extending outwardly from the external surface of the fuel cell system housing.

27. A method for regulating power in a fuel cell system, comprising:
measuring a power demand of an external load;
determining a voltage from an external power adaptor having a rechargeable battery;
determining a power limit for a fuel cell included in the fuel cell system;
providing power from the rechargeable battery to the load when the power demand from the external load is greater than the power limit for the fuel cell; and
providing power to the rechargeable battery from the fuel cell when the power demand from the load is less than the power limit for the fuel cell.

28. The method of claim 27, wherein the providing further comprises limiting power output from the fuel cell by a power limiting circuit in the fuel cell.

29. The method of claim 27, wherein the power limiting circuit is in electrical communication with the rechargeable battery.

30. The method of claim 28, wherein the power limiting circuit is in electrical communication with the external load.
